(19) United States
(12) Patent Application Publication
(10) Pub. No.: US 2026/0351469 A1
(43) Pub. Date: Nov. 5, 2026

(54) ELECTRICALLY INSULATED MULTILAYER COIL FOR ELECTRICAL TRANSFORMER

(71) Applicants: SUPERGRID INSTITUTE, Villeurbanne (FR); GENERAL ELECTRIC TECHNOLOGY GMBH, Baden (CH)

(72) Inventors: Paul Vinson, Lyon (FR); Alain Girodet, Chassieu (FR); Samuel Fifi, Aix-Les-Bains (FR); Tommy Barbe, Aix-Les-Bains (FR)

(21) Appl. No.: 19/116,308

(22) PCT Filed: Oct. 7, 2023
(86) PCT No.: PCT/EP2023/077804

§ 371 Date: Mar. 27, 2025

(30) Foreign Application Priority Data
Oct. 7, 2022 (FR) FR2210274

(51) Int. Cl. H01F 27/32; H01F 27/02; H01F 27/28

(52) U.S. Cl. CPC H01F 27/323; H01F 27/02; H01F 27/2823

(57) ABSTRACT

The solution proposed by the invention is a multilayer coil for an electrical transformer suitable for the use of insulating fluids that are less polluting than conventional insulating fluids. The coil (1) according to the invention is characterized in that the first overhang length (L1i), and/or the second overhang length (L2i), of at least one electrically insulating layer (12i) is greater than the first overhang length (L1j), and/or respectively the second overhang length (L2j), of at least one further electrically insulating layer (12j).

### TECHNICAL FIELD OF THE INVENTION

The present invention relates to the technical field of electrical transformers and more particularly to multilayer coils for electrical transformers.

### PRIOR ART

Electrical transformers of the type described in the IEC61869-1, IEC61869-3 and IEC61869-4 standards are known. A transformer of this type comprises a multilayer coil (10) such as that shown in FIG. 1. The coil (10) generally comprises an electrically conductive portion (101) and an electrically insulating portion (102).

The electrically conductive portion (101) comprises a plurality of electrically conductive layers. Each of the electrically conductive layers comprises a conductive wire which is wound in a spiral around an axis (AO) and extends axially from a first plane orthogonal to said axis to a second plane orthogonal to said axis. The electrically conductive layers are arranged coaxially around one another.

The electrically insulating portion (102) comprises a plurality of electrically insulating layers. Each of the electrically insulating layers is arranged between two of the electrically conductive layers so as to insulate the two electrically conductive layers from one another. In practice, each of the electrically insulating layers can be in the form of a plurality of superposed insulating sub-layers of the same length. The electrically insulating layer comprises a first and a second overhang zone extending axially over a first, respectively second, overhang length in an axial direction, beyond the first, respectively second, orthogonal plane of the longer of the two electrically conductive layers. These overhang zones are designed to limit the creation of electric arcs between the electrically conductive layers at the ends of the coil (10). This overhang length is identical for all layers. Also, the overhang zones prevent the conductive wire from slipping off the coil under the effect of the mechanical tension applied by the machine during winding.

To increase the insulation between electrically conductive layers at the ends of the coil (10), the latter is arranged in a pressurized enclosure into which an electrically insulating fluid is injected so as to envelop the coil. These can be oil-or gas-type fluids.

However, the fluids with the best performance in terms of electrical insulation are also the most polluting. We will refer to these commonly used high-performance fluids as conventional insulating fluids. This is particularly the case for sulfur hexafluoride (SF6). It is therefore necessary to develop solutions which employ less-polluting fluids, for example oxygen, dinitrogen, carbon dioxide, fluoronitrile, fluoroketone, a mixture of fluoronitrile, or fluoroketone with oxygen or dinitrogen or carbon dioxide, a mixture of sulfur hexafluoride with a significant quantity of dinitrogen, etc.

As it stands, however, simply substituting one fluid for another can damage the insulation to such an extent that electric arcing can occur, known as breakdown. On this type of transformer with a pressurized enclosure, the appearance of electric arcs frequently results in the destruction of the coil.

It is therefore the object of the invention to provide a multilayer coil for an electrical transformer that is suitable for the use of insulating fluids having a dielectric strength which is lower than that of sulfur hexafluoride and preferably less polluting than conventional insulating fluids.

### DISCLOSURE OF THE INVENTION

The solution proposed by the invention is a coil for an electric transformer comprising:
an electrically conductive portion comprising a plurality of electrically conductive layers, each of said electrically conductive layers comprising a conductive wire that is wound in a spiral around an axis and extends axially from a first plane orthogonal to said axis to a second plane orthogonal to said axis, said electrically conductive layers being arranged coaxially around one another,
an electrically insulating portion comprising a plurality of electrically insulating layers, each of said electrically insulating layers being arranged between two of said electrically conductive layers so as to insulate the two electrically conductive layers from one another, said electrically insulating layer comprising a first overhang zone and a second overhang zone extending axially over a first, respectively second, overhang length, beyond the first, respectively second, plane, of the longer of the two electrically conductive layers.

This coil is characterized in that the first overhang length, and/or the second overhang length, of at least one first electrically insulating layer is greater than the first overhang length, and/or respectively the second overhang length, of at least one further electrically insulating layer.

Thus, the creation of irregularities in the overhang length of the different electrically insulating layers makes it possible to improve the capacity of the insulation to prevent the occurrence of electric arcs.

According to another advantageous feature of the invention which makes it possible to improve the capacity of the insulation to prevent the appearance of electric arcs by creating significant irregularities:
the conductive wire of each electrically conductive layer has a diameter, and
the first overhang length, or the second overhang length, of the at least one first electrically insulating layer is greater than the first, or respectively second, overhang length of the second electrically insulating layer by at least twenty times the diameter of said conductive wire.

According to another advantageous feature of the invention which makes it possible to improve the capacity of the insulation to prevent the appearance of electric arcs by optimizing the overhang lengths:
the conductive wire of each electrically conductive layer has a diameter, and
the first overhang length and the second overhang length of each electrically insulating layer are between forty and three hundred and twenty times the diameter of said conductive wire.

According to yet another advantageous feature of the invention which makes it possible to improve the capacity of the insulation to prevent the appearance of electric arcs by generating a crenelated profile:
the conductive wire of each electrically conductive layer has a diameter, and
the electrically insulating layers are divided into a short overhang group and a long overhang group,
the first overhang length and the second overhang length of the electrically insulating layers of said short overhang group are between forty and one hundred times the diameter of said conductive wire,
the first overhang length and the second overhang length of the electrically insulating layers of said long overhang group are between one hundred and twenty and three hundred and twenty times the diameter of said conductive wire.

According to yet another advantageous feature of the invention which makes it possible to improve the capacity of the insulation to prevent the occurrence of electric arcs by optimizing the width and thickness of the notches:
the short overhang group is composed of short overhang subgroups of two to four consecutive electrically insulating layers,
the long overhang group is composed of long overhang subgroups of two to four consecutive electrically insulating layers,
the insulating portion being formed through an alternation between short overhang subgroups and long overhang subgroups.

According to yet another advantageous feature of the invention which makes it possible to improve the capacity of the insulation to prevent the appearance of electric arcs by generating an asymmetrical crenelated profile at the two ends of the coil:
the conductive wire of each electrically conductive layer has a diameter, and
the electrically insulating layers are divided into a group with a first short overhang and a second long overhang, and a group with a first long overhang and a second short overhang,
the first overhang length of the electrically insulating layers of the group with a first short overhang and a second long overhang, and the second overhang length of the electrically insulating layers of the group with a first long overhang and a second short overhang are between forty and one hundred times the diameter of said conductive wire,
the second overhang length of the electrically insulating layers of the group with a first short overhang and a second long overhang, and the first overhang length of the electrically insulating layers of the group with a first long overhang and a second short overhang are between one hundred and twenty and three hundred and twenty times the diameter of the conductive wire.

According to yet another advantageous feature of the invention which makes it possible to improve the capacity of the insulation to prevent the occurrence of electric arcs by optimizing the width and thickness of the notches:
the group with first short overhang and second long overhang is composed of subgroups with first short overhang and second long overhang of two to four consecutive electrically insulating layers,
the group with first long overhang and second short overhang is composed of subgroups with first long overhang and second short overhang of two to four consecutive electrically insulating layers,
the insulating portion being formed through an alternation between subgroups with first short overhang and second long overhang and subgroups with first long overhang and second short overhang.

According to yet another advantageous feature of the invention which makes it possible to improve the capacity of the insulation to prevent the occurrence of electric arcs by generating a profile in which the variation in length is more progressive by successively selecting the electrically insulating layers radially from the inside to the outside, the first overhang length, and/or the second overhang length of an electrically insulating layer increases, or decreases, relative to the first overhang length, and/or respectively the second overhang length of the preceding electrically insulating layer, up to a maximum length, or respectively to a minimum length, then decreases, or respectively increases, up to said minimum length, or respectively to said maximum length.

According to yet another advantageous feature of the invention which makes it possible to improve the capacity of the insulation to prevent the occurrence of electric arcs by optimizing the minimum and maximum lengths, the minimum length is between forty and one hundred times the diameter of the conductive wire and the maximum length is between one hundred and twenty and three hundred and twenty times the diameter of the conductive wire.

According to yet another advantageous feature of the invention which makes it possible to improve the capacity of the insulation to prevent the occurrence of electric arcs, the first overhang length, and/or the second overhang length, increase or decrease according to a sinusoidal function.

Another aspect of the invention relates to an electrical transformer comprising:
an enclosure,
at least one coil arranged inside the enclosure, and
an electrically insulating fluid arranged inside the enclosure and enveloping said at least one coil.
   This transformer is characterized in that said at least one coil is a coil as defined above.

Thus, in such a transformer, the creation of irregularities in the overhang length of the different electrically insulating layers makes it possible to improve the capacity of the insulation to prevent the occurrence of electric arcs.

### DESCRIPTION OF THE FIGURES

Other features and advantages of the invention will emerge from the description which follows of specific embodiments of the invention, which are given by way of illustration and are not limitative, with reference to the appended drawings, in which:

FIG. 1 is a schematic sectional view of the coil of the prior art;

FIG. 2 is a schematic sectional view of a first exemplary embodiment of the coil constituting the object of the invention with a symmetrical crenelated insulation profile;

FIG. 3 is a schematic view of detail D1 of the first exemplary embodiment shown in FIG. 2;

FIG. 4 is a schematic view of detail D2 of the first exemplary embodiment shown in FIG. 2;

FIG. 5 is a schematic sectional view of a second exemplary embodiment of the coil constituting the object of the invention with an asymmetrical crenelated insulation profile;

FIG. 6 is a schematic sectional view of a third exemplary embodiment of the coil constituting the object of the invention with a symmetrical sinusoidal insulation profile;

FIG. 7 is a schematic sectional view of a fourth exemplary embodiment of the coil constituting the object of the invention with an insulation profile with a constant short overhang length;

FIG. 8 is a schematic sectional view of a fifth exemplary embodiment of the coil constituting the object of the invention with a cylindrical conductive profile and a symmetrical crenelated insulation profile;

FIG. 9 is a schematic sectional view of a sixth exemplary embodiment of the coil constituting the object of the invention with a parabolic conductive profile and a symmetrical crenelated insulation profile.

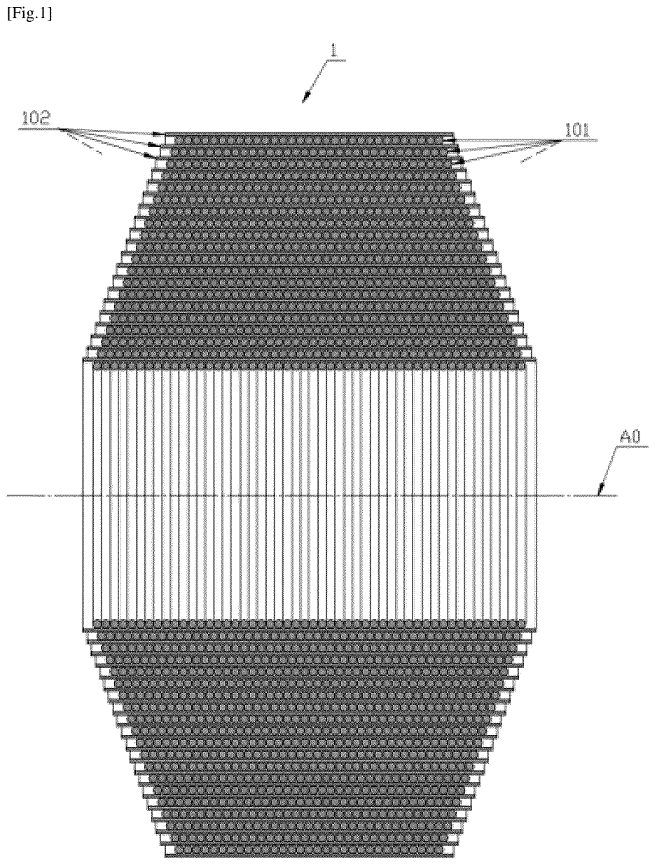

FIGS. 1 to 9 do not reflect the actual dimensions of the components. The dimensions of certain elements may have been enlarged or reduced in order to facilitate the reader's understanding. In particular, the ratio of overhang length to conductor wire diameter shown in the figures does not reflect reality.

### DETAILED DESCRIPTION

The invention relates to a coil (1) for an electric transformer. The electrical transformer can be a measuring transformer, a power transformer, or one of another type. The electrical transformer can be single-phase or three-phase.

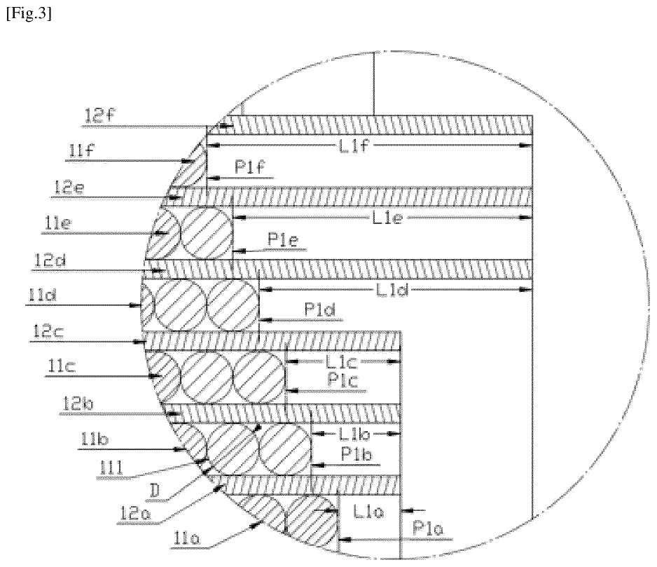

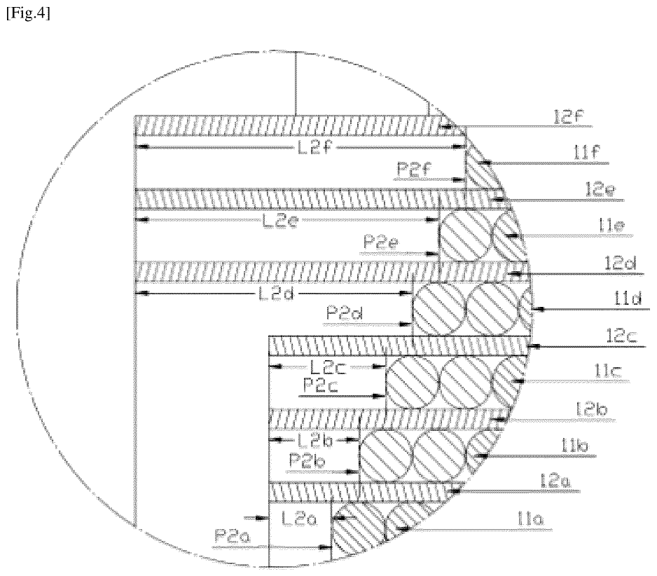

The coil (1) comprises an electrically conductive portion (11). The latter comprises a plurality of electrically conductive layers (11a, 11b, 11c, 11d, 11f, etc.). In the remainder of the description, and for the sake of simplification, we will designate as an electrically conductive layer (11i) any electrically conductive layer among all of the electrically conductive layers. “i” is a variable that can take a letter of the alphabet as a value so as to allow a distinction to be made between the electrically conductive layers, like in the example of FIGS. 3 and 4, where:
i=a for the electrically conductive layer (11a) closest to the axis,
i=b for the next-closest electrically conductive layer (11b) to the axis (A),
i=c for the next-closest electrically conductive layer (11c) to the axis (A),
and so forth.
   Alternatively, the variables “j” or “k” can be used in a similar manner in the remainder of the description.

In practice, the coil (1) can comprise between 50 and 150 electrically conductive layers (11i). Each of said electrically conductive layers (11i) comprises a conductive wire (111). The conductive wire (111) is preferably an enameled conductive wire. The conductive wire (111) preferably comprises a core made of copper, but it can be made of aluminum or any other conductive material deemed suitable by those skilled in the art. The conductive wire (111) of each electrically conductive layer (11i) can have a diameter (D). The latter can be between 0.125 mm and 0.3 mm. The conductive wire (111) is wound in a spiral around an axis (A) and extends axially from a first plane (P1i) orthogonal to the axis (A) to a second plane (P2i) orthogonal to the axis (A). The electrically conductive layers (11i) are arranged coaxially around one another.

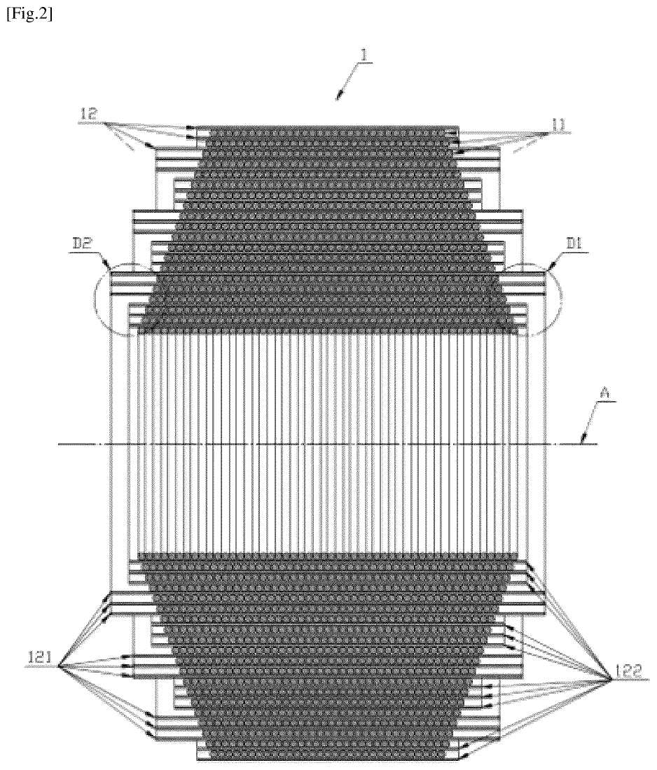

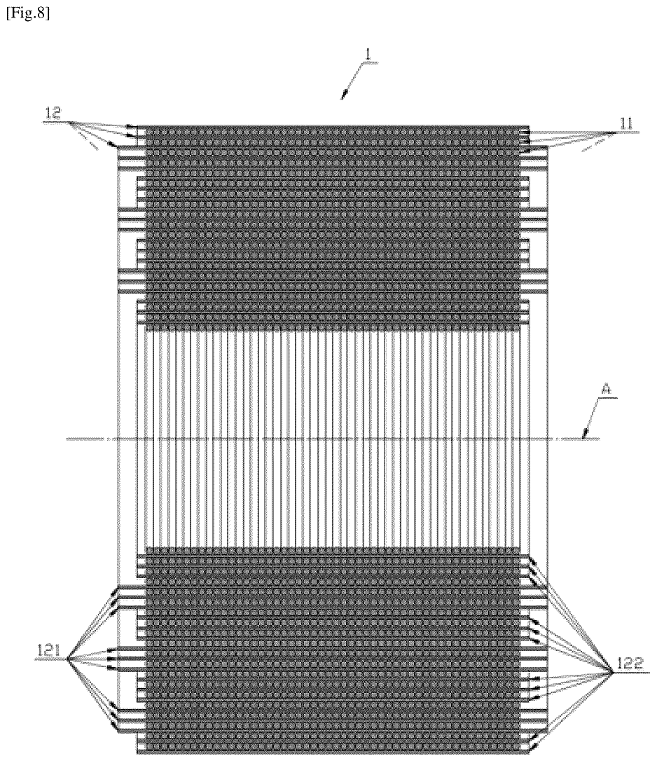

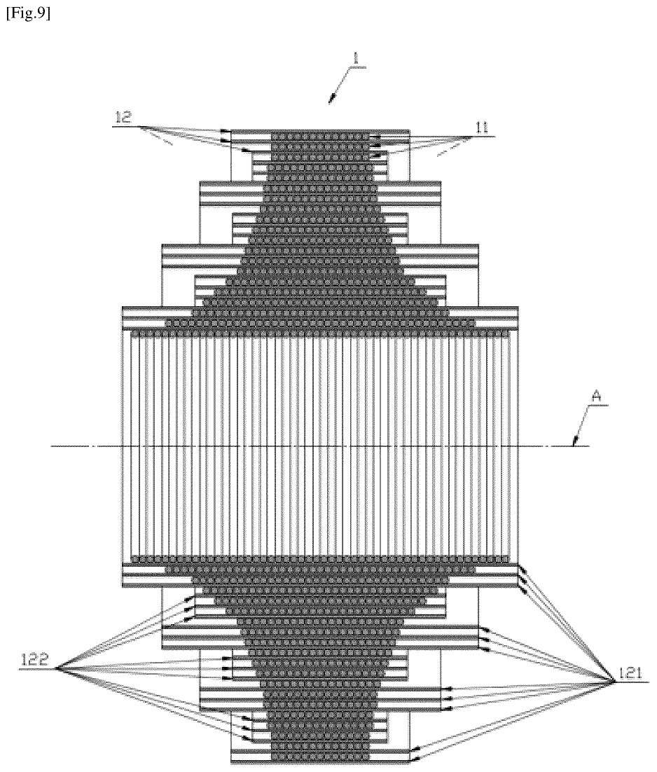

Each winding of conductive wire (111) in the electrically conductive layer (11i) is called a turn. For each electrically conductive layer (11i), the number of turns can be between 1 and 2500. In some embodiments, such as those shown in FIGS. 2 to 6 and FIG. 9, the number of turns may decrease from the conductive layer (11a) closest to the axis to the conductive layer farthest from the axis. The number of turns can decrease linearly, as in the exemplary embodiments shown in FIGS. 2 to 6. This type of coil is generally referred to as a “trapezoidal coil.” The number of turns can decrease in a non-linear manner, for example according to a parabola as in the exemplary embodiment shown in FIG. 9. This latter type of coil is generally called a “parabolic coil.” In other embodiments, and in particular in the exemplary embodiment of FIG. 8, the number of turns may be identical for all of the electrically conductive layers (11i). This type of coil is generally referred to as a “cylindrical coil.” In yet other embodiments, which are not shown, the number of turns may decrease by one to five turns for every three to ten electrically conductive layers (11i).

The coil (1) also comprises an electrically insulating portion (12). The electrically insulating portion (12) comprises a plurality of electrically insulating layers (12i). In the remainder of the description, and for the sake of simplification, we will designate as an electrically insulating layer (12i) any electrically insulating layer among all of the electrically insulating layers. “i” is a variable that can take a letter of the alphabet as a value so as to allow a distinction to be made between the electrically insulating layers, like in the example of FIGS. 3 and 4, where:
i=a for the electrically insulating layer (12a) closest to the axis,
i=b for the next-closest electrically insulating layer (12b) to the axis (A),
i=c for the next-closest electrically insulating layer (12c) to the axis (A),
and so forth.
   Alternatively, the variables “j” or “k” can be used in a similar manner in the remainder of the description.

Each electrically insulating layer (12i) comprises one or more electrically insulating materials of the polyester film type partially covered on both sides with glue, or others. Preferably, the insulating material has a dielectric strength of greater than 50 kV/mm.

Each of the electrically insulating layers (12i) is arranged between two of the electrically conductive layers (11i) so as to insulate the two electrically conductive layers from one another. In practice, an electrically insulating layer (12i) can be made by winding a strip of electrically insulating material around an electrically conductive layer. In this case, the strip of electrically insulating material can have a width of between 50 mm and 350 mm and a thickness of between 20 μm and 50 μm. The winding can be done edge to edge or with an overlap. The electrically insulating layer (12i) may comprise a plurality of superposed windings made of the same insulating material or of different insulating materials. Advantageously, the electrically insulating layer (12 i) comprises 2 to 4 superposed windings.

Each electrically insulating layer (12i) comprises and is extended by a first overhang zone extending axially over a first overhang length (L1i) beyond the first orthogonal plane (P1i) of the longer of the two adjoining electrically conductive layers (11i).

It can also be seen in the figures and holds for all of the embodiments that will be described that the electrically conductive layers (11i) overlap axially at least in part.

The electrically insulating layers (12i) are generally cylindrical in shape, and said electrically insulating layers (12i) are arranged coaxially around one another and overlap axially at least in part.

For example, with reference to FIG. 3, the electrically insulating layer (12a) comprises a first overhang zone extending axially over a first overhang length (L1a) beyond the first orthogonal plane (P1a) of the longer electrically conductive layer (11a) of the two adjoining electrically conductive layers (11a, 11b). The same holds true:
for the electrically insulating layer (12b) having a first overhang length (L1b) relative to the first orthogonal plane (P1b),
for the electrically insulating layer (12c) having a first overhang length (L1c) relative to the first orthogonal plane (P1c),
for the electrically insulating layer (12d) having a first overhang length (L1d) relative to the first orthogonal plane (P1d),
for the electrically insulating layer (12e) having a first overhang length (L1e) relative to the first orthogonal plane (P1e),
for the electrically insulating layer (12f) having a first overhang length (L1f) relative to the first orthogonal plane (P1f),
and so forth.

Advantageously, the first overhang length (L1i) is greater than forty times the diameter (D) of the conductive wire. Preferably, the first overhang length (L1i) is greater than seventy times the diameter (D) of the conductive wire.

Each electrically insulating layer (12i) comprises a second overhang zone extending axially over a second overhang length (L2i) beyond the second orthogonal plane (P2i) of the longer of the two adjoining electrically conductive layers (11i).

For example, with reference to FIG. 4, the electrically insulating layer (12a) comprises a second overhang zone extending axially over a second overhang length (L2a) beyond the second orthogonal plane (P2a) of the longer electrically conductive layer (11a) of the two electrically conductive layers (11a, 11b). The same holds true:
for the electrically insulating layer (12b) having a second overhang length (L2b) relative to the second orthogonal plane (P2b),
for the electrically insulating layer (12c) having a second overhang length (L2c) relative to the second orthogonal plane (P2c),
for the electrically insulating layer (12d) having a second overhang length (L2d) relative to the second orthogonal plane (P2d),
for the electrically insulating layer (12e) having a second overhang length (L2e) relative to the second orthogonal plane (P2e),
for the electrically insulating layer (12f) having a first overhang length (L2f) relative to the first orthogonal plane (P2f),
and so forth.

Advantageously, the second overhang length (L2i) is greater than forty times the diameter (D) of the conductive wire. Preferably, the second overhang length (L2i) is greater than seventy times the diameter (D) of the conductive wire.

With reference to FIG. 2 and FIGS. 5 to 9, the electrical transformer is characterized in that the first overhang length (L1j), and/or the second overhang length (L2j), of at least one first electrically insulating layer (12j) is greater than the overhang length (L1k), and/or the second overhang length (L2k), of at least one further electrically insulating layer (12k).

In a manufacturing process based on cutting electrically insulating layers initially having the same dimensions, it can be noted that the technical effect of the invention is obtained without additional cost, with the best breakdown resistance being obtained without the addition of material for the electrically insulating layers.

The first overhang length (L1j), or the second overhang length (L2j), of the at least one first electrically insulating layer (12j) is advantageously greater than the first overhang length (L1k), or respectively the second overhang length (L2k) of the second electrically insulating layer (12k), by at least twenty times the diameter (D) of the conductive wire (111), expediently by at least fifty times the diameter (D) of the conductive wire (111), and preferably by at least one hundred times the diameter (D) of the conductive wire (111).

Advantageously, the first overhang length and the second overhang length (L1i, L2i) of each electrically insulating layer (12i) is between forty and three hundred and twenty times the diameter (D) of the conductive wire (111).

Each electrically insulating layer (12i) may comprise:
either two long overhangs
or two short overhangs
or one long overhang and one short overhang.

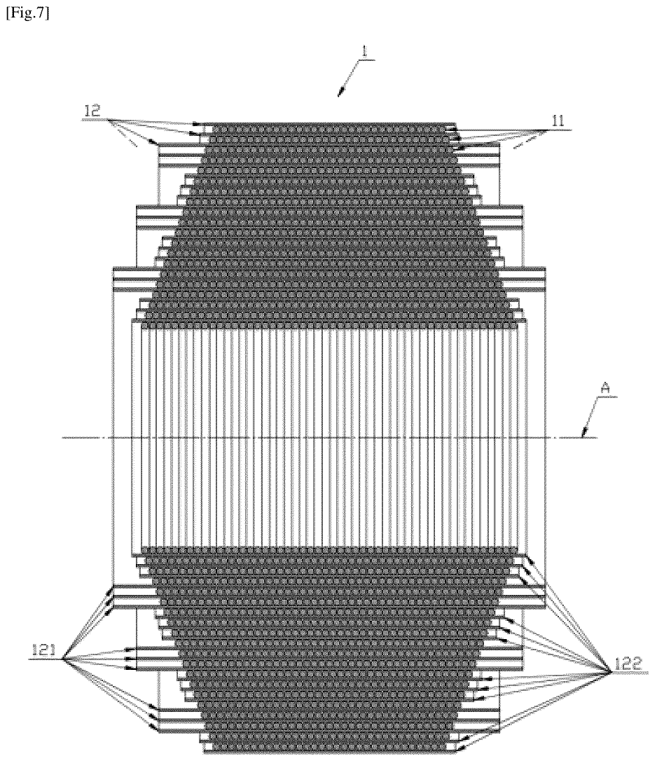

“Short overhang” means that the overhang length (L1i, L2i) of the electrically insulating layer is between forty and one hundred times the diameter (D) of the conductive wire (111). The short overhangs can have different lengths, as in the exemplary embodiments shown in FIGS. 1 to 6 and FIGS. 8 and 9. In alternative embodiments, and as in the exemplary embodiment shown in FIG. 7, the short overhangs can all have the same length. For example, it is possible to keep conventional overhangs as short overhangs and to lengthen certain overhangs to make them long overhangs. In other embodiments, which are not shown, some short overhangs may have the same length, and others not.

“Long overhang” means that the overhang length (L1i, L2i) of the electrically insulating layer is between one hundred and twenty and three hundred and twenty times the diameter (D) of the conductive wire (111). The long overhangs can have different lengths, as in the exemplary embodiments shown in FIGS. 1 to 6 and FIGS. 8 and 9. In alternative embodiments, which are not shown, the long overhangs may all have the same length. In other embodiments, which are not shown, some short overhangs may have the same length, and others not.

In some embodiments, the innermost electrically insulating layer (12a) of the coil (1) may have two short overhangs. In other embodiments, the innermost electrically insulating layer (12a) of the coil (1) may have two long overhangs. In yet other embodiments, the innermost electrically insulating layer (12a) of the coil (1) may have a long overhang and a short overhang.

In a first embodiment, the electrically insulating layers (12i) are divided into a short overhang group (122) and a long overhang group (121). In other words:
The first overhang length (L1j) and the second overhang length (L2j) of the electrically insulating layers (12j) of the short overhang group (122) is between forty and one hundred times the diameter (D) of the conductive wire (111), and
the first overhang length (L1k) and the second overhang length (L2k) of the electrically insulating layers (12k) of the long overhang group (121) is between one hundred and twenty and three hundred and twenty times the diameter (D) of the conductive wire (111).

Generally, the short overhang group (122) can be composed of short overhang subgroups of two to four consecutive electrically insulating layers (12j). Also, the long overhang group (121) can be composed of long overhang subgroups of two to four consecutive electrically insulating layers (12k). Thus, the insulating portion (12) is formed through an alternation between short overhang subgroups and long overhang subgroups.

In the exemplary embodiment shown in FIG. 2, the short overhang group (122) is composed of:
three short-overhang subgroups of three consecutive electrically insulating layers (12j), and
one short-overhang subgroup of two consecutive electrically insulating layers (12j).

The long overhang group (121) is composed of three long overhang subgroups of three consecutive electrically insulating layers (12k).

In a second embodiment, the electrically insulating layers (12i) are divided into a group with a first short overhang and a second long overhang (123) and a group with a first long overhang and a second short overhang (124). In other words:
For electrically insulating layers (12j) of the group with first short overhang and second long overhang (123):
   The first overhang length (L1j) is between forty and one hundred times the diameter (D) of the conductive wire (111), and
   the second overhang length (L2j) is between one hundred and twenty and three hundred and twenty times the diameter (D) of the conductive wire (111);
for the electrically insulating layers (12k) of the group with first long overhang and second short overhang (124):
   The first overhang length (L1k) is between one hundred and twenty and three hundred and twenty times the diameter (D) of the conductive wire (111), and
   the second overhang length (L2k) is between forty and one hundred times the diameter (D) of the conductive wire (111).

Generally, the first short overhang and second long overhang group (123) is composed of first short overhang and second long overhang subgroups of two to four consecutive electrically insulating layers (12j). Also, the first long overhang and second short overhang group (124) is composed of first long overhang and second short overhang subgroups of two to four consecutive electrically insulating layers (12k). Thus, the insulating portion (12) is formed through an alternation between subgroups with first short overhang and second long overhang and subgroups with first long overhang and second short overhang.

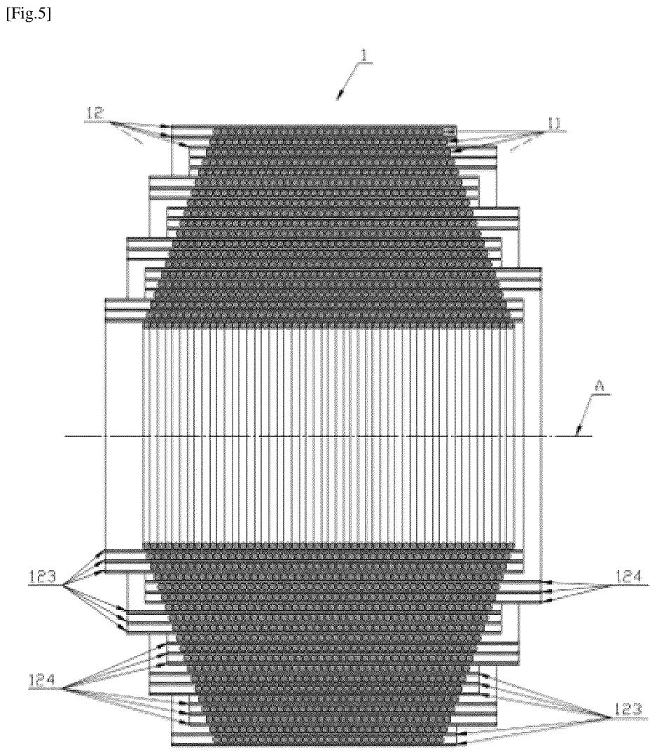

In the exemplary embodiment shown in FIG. 5, the short overhang and second long overhang group (123) is composed of:
three subgroups with short overhang and second long overhang of each three consecutive electrically insulating layers (12i), and
one subgroup with short overhang and second long overhang of two consecutive electrically insulating layers (12i).

The group with first long overhang and second short overhang (124) is itself composed of three subgroups with first long overhang and second short overhang, each with three consecutive electrically insulating layers (12j).

In a third embodiment, the overhang lengths increase or decrease gradually.

For example, by successively selecting the electrically insulating layers radially from the inside to the outside, the first overhang length (L1j) of an electrically insulating layer (12j) increases, or decreases, relative to the first overhang length (L1k) of the preceding electrically insulating layer (12k) up to a maximum length, or respectively to a minimum length, then decreases, or respectively increases, up to the minimum length, or respectively to the maximum length.

Alternatively to, or in combination with, the preceding paragraph, the second overhang length (L2j) of an electrically insulating layer (12j) increases or decreases relative to the second overhang length (L2k) of the preceding electrically insulating layer (12k) up to a maximum length or respectively to a minimum length, and then decreases or increases respectively to the minimum length or respectively to the maximum length.

Advantageously, the minimum length is between forty and one hundred times the diameter of the conductive wire. Also advantageously, the maximum length is between one hundred and twenty and three hundred and twenty times the diameter of the conductive wire.

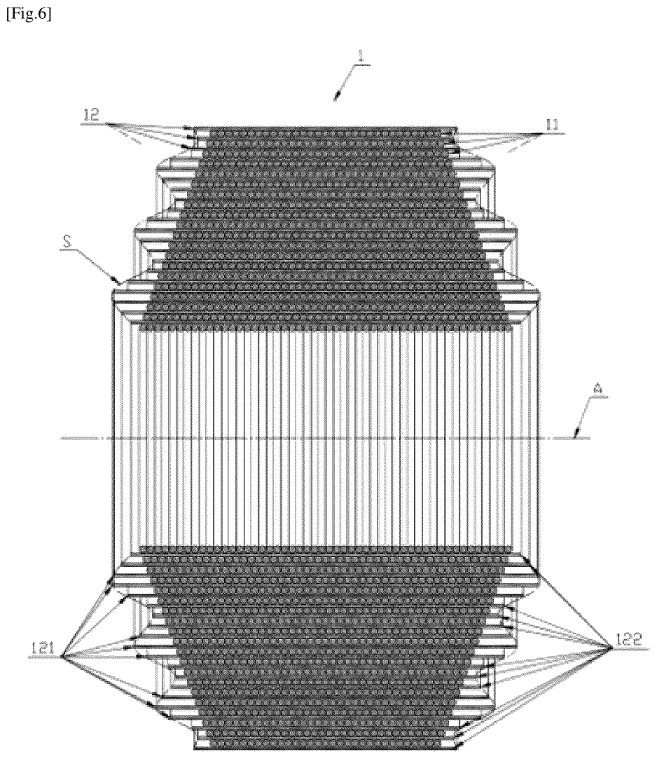

Expediently, and as in the exemplary embodiment shown in FIG. 6, the first overhang length (L1i) and/or the second overhang length (L2i) increase or decrease according to a sinusoidal function(S).

Another aspect of the invention relates to an electrical transformer. This electrical transformer can be a measuring transformer intended to supply measuring devices, meters, relays, and other similar devices. In particular, this transformer can be a voltage transformer. This transformer can also be a power transformer. The electrical transformer can be single-phase or three-phase.

The electrical transformer comprises an enclosure. This enclosure is preferably metallic, but it can also be made of any material deemed suitable by those skilled in the art. The enclosure preferably has a cylindrical shape, but it can also have any shape deemed suitable by those skilled in the art.

The electrical transformer also comprises at least one coil (1) according to the invention. The coil (1) is arranged inside the enclosure. When the electrical transformer is single-phase, said transformer comprises a single coil (1) arranged inside the enclosure. When the electrical transformer is three-phase, said transformer comprises three coils (1) arranged inside the enclosure.

The transformer further comprises an electrically insulating fluid arranged inside the enclosure and surrounding the coil (1). This electrically insulating fluid may be of the oil type such as those described in the IEC60296 standard, insulating liquid such as those described in the IEC60867 standard, sulfur hexafluoride (SF6), or any other electrically insulating fluid deemed suitable by those skilled in the art. Preferably, and in order to limit the risks of pollution associated with possible leaks from the enclosure, the fluid used is of a type from among oxygen, nitrogen, carbon dioxide, fluoronitrile, fluoroketone, a mixture of fluoronitrile or fluoroketone with oxygen or nitrogen or carbon dioxide, or a mixture of sulfur hexafluoride with a significant quantity of nitrogen, etc. In practice, the insulating fluid has a dielectric strength of greater than 2 kV/mm. The fluid can be arranged under pressure inside the enclosure. In particular, the fluid pressure can be between 3.5 bar rel and 6.3 bar rel.

1-14. (canceled)

15. A coil for electric transformer, comprising:
an electrically conductive portion comprising a plurality of electrically conductive layers, each of said electrically conductive layers comprising a conductive wire that is wound in a spiral around an axis and extends axially from a first plane orthogonal to said axis to a second plane orthogonal to said axis, said electrically conductive layers being arranged coaxially around one another,
an electrically insulating portion comprising a plurality of electrically insulating layers, each of said electrically insulating layers being arranged between two of said electrically conductive layers so as to insulate the two electrically conductive layers from one another, said electrically insulating layer comprising a first overhang zone and a second overhang zone extending axially over a first, respectively second, overhang length, beyond the first, respectively second, plane of the longer of the two electrically conductive layers,
characterized in that the first overhang length, and/or the second overhang length, of at least one first electrically insulating layer is greater than the first overhang length, and/or respectively the second overhang length, of at least one further electrically insulating layer.

16. The coil according to claim 15, characterized in that said electrically conductive layers overlap axially at least in part.

17. The coil according to claim 15, characterized in that the electrically insulating layers are generally cylindrical in shape and that said electrically insulating layers are arranged coaxially around one another and overlap axially at least in part.

18. The coil according to claim 15, characterized in that the electrically insulating layer is extended by a first overhang zone and by a second overhang zone extending axially.

19. The coil according to claim 15, characterized in that:
the conductive wire of each electrically conductive layer has a diameter, and the first overhang length, or the second overhang length, of the at least one first electrically insulating layer is greater than the first overhang length, or respectively second overhang length, of the second electrically insulating layer by at least twenty times the diameter of said conductive wire.

20. The coil according to claim 15, characterized in that:
the conductive wire of each electrically conductive layer has a diameter, and the first overhang length and the second overhang length of each electrically insulating layer are between forty and three hundred and twenty times the diameter of said conductive wire.

21. The coil according to claim 15, characterized in that:
the conductive wire of each electrically conductive layer has a diameter, and the electrically insulating layers are divided into a short overhang group and a long overhang group,
the first overhang length and the second overhang length of the electrically insulating layers of said short overhang group are between forty and one hundred times the diameter of said conductive wire,
the first overhang length and the second overhang length of the electrically insulating layers of said long overhang group are between one hundred and twenty and three hundred and twenty times the diameter of said conductive wire.

22. The coil according to claim 21, characterized in that:
the short overhang group is composed of short overhang subgroups of two to four consecutive electrically insulating layers,
the long overhang group is composed of long overhang subgroups of two to four consecutive electrically insulating layers,
the insulating portion being formed through an alternation between short overhang subgroups and long overhang subgroups.

23. The coil according to claim 15, characterized in that:
the conductive wire of each electrically conductive layer has a diameter, and the electrically insulating layers are divided into a group with a first short overhang and a second long overhang, and a group with a first long overhang and a second short overhang, the first overhang length of the electrically insulating layers of the group with a first short overhang and a second long overhang, and the second overhang length of the electrically insulating layers of the group with a first long overhang and a second short overhang are between forty and one hundred times the diameter of said conductive wire, the second overhang length of the electrically insulating layers of the group with a first short overhang and a second long overhang, and the first overhang length of the electrically insulating layers of the group with a first short overhang and a second long overhang are between one hundred and twenty and three hundred and twenty times the diameter of said conductive wire.

24. The coil according to claim 21, characterized in that:
the group with first short overhang and second long overhang is composed of subgroups with first short overhang and second long overhang of two to four consecutive electrically insulating layers,
the group with first long overhang and second short overhang is composed of subgroups with first long overhang and second short overhang of two to four consecutive electrically insulating layers,
the insulating portion being formed through an alternation between subgroups with first short overhang and second long overhang and subgroups with first long overhang and second short overhang.

25. The coil according to claim 15, characterized in that, through successive selection of the electrically insulating layers radially from the inside to the outside, the first overhang length, and/or the second overhang length, of an electrically insulating layer increases, or decreases, relative to the first overhang length, and/or respectively to the second overhang length, of the preceding electrically insulating layer up to a maximum length, or respectively a minimum length, then decreases, or respectively increases, up to said minimum length, or respectively to said maximum length.

26. The coil according to claim 25, characterized in that the minimum length is between forty and one hundred times the diameter of the conductive wire and the maximum length is between one hundred and twenty and three hundred and twenty times the diameter of the conductive wire.

27. The coil according to claim 25, characterized in that the first overhang length, and/or the second overhang length increase or decrease according to a sinusoidal function.

28. The electrical transformer, comprising:
an enclosure,
at least one coil arranged inside the enclosure, and
an electrically insulating fluid arranged inside the enclosure and enveloping said at least one coil, characterized in that said at least one coil is a coil according to claim 15.
